(19) United States
(12) Patent Application Publication
(10) Pub. No.: US 2017/0120990 A1
(43) Pub. Date: May 4, 2017

(54) Emergency Detachable Island Rig

(71) Applicant: Sumathi Paturu, Birmingham, AL (US)

(72) Inventor: Sumathi Paturu, Birmingham, AL (US)

(21) Appl. No.: 14/756,974

(22) Filed: Nov. 3, 2015

(51) Int. Cl. B63B 23/30; B63B 45/04; G05D 1/00; B63B 29/02; B63B 35/44

(52) U.S. Cl. CPC B63B 23/30; B63B 29/02; B63B 35/44; G05D 1/0011; B63B 45/04; E02B 17/00

(57) ABSTRACT

The invention describes a schematic of a ‘Detachable Island Rig’ (DIR) locked on an immovable base (providing stable working platform), to be instantly detached in the event of a rig-fire, the DIR having additional conduction platform, costly equipment, living quarters, a steering station, and uniquely designed life-boats and lift-boats. The electrical wiring and metal tubing (with intervening rubber tubing) are cut after clamping, before the DIR's dis-engagement.

For stationing back onto the base structure devised for staying submerged in water, the DIR is pulled down by a system of double pulleys on the sides of the base structure, when also the DIR is in a position to be locked to the permanent base. The under-water basement houses electrical generators, a ‘power-source’ not to be destroyed by fire, and accessed at a level far above the ocean waters, through the top of a staircase-room erected from the basement.

### BACKGROUND OF THE INVENTION

There are innumerable petroleum oil wells bored into the oceanic floor by highly evolved modern technological devices to tap the petroleum (crude oil) reservoirs. Many oil wells are clustered in the Gulf of Mexico, Arabian sea, and such oceanic grounds, often of significant distance from the coast line, such wells bored through the ocean floor as far deep as a mile from the surface waters, to find their way into the underground oil containments spread many miles in area. Oil is collected from the wells into surface tanks in modcrate containers, or into receptacles as large as ships.

The drilling and production of petroleum oil from the earth's mantle in the ocean floor is shrouded in risk and great hazard to the natural environment that includes both the marine life forms and the terrestrial ecosystem adjacent. The greatest hazard is the ignition of the entrained highly inflammable gases like Methane, causing dangerous fires coupled with the risk of oil spewing and polluting the sea water. Such two man-made calamities at the same time can be uncontrollable with available resources, and utterly devastating to the healthy existence of the earth's planetary life forms. For these reasons, error-proof safety systems in under water bore well digging, and highly trained personnel are required by law in all countries engaged in significant oil production. Despite such stringent laws, system failures and catastrophic results did occur historically (and still occurring), though the derived remedial measures through each ‘adverse-event experience’ uniquely different from the other in some form or other, are still nascent and less than perfect.

Recent event in the gulf shores of Mexico (involving BP oil company's oil well under construction, the Deep Water Horizon), wherein the ignition of the entrained Methane gas and its fire that continued unstopped for 36 hours, culminated in collapse of the surface structure of the oil well, resulting in an ever increasing gusher from the source. Several different attempts from BP oil company's technological team to contain the spewing geyser from finding its way into the body of water, and into the gulf shores had failed, mostly due to the inherently limited robotic attempts involved in a moderately deep aquatic habitat.

As any unforeseen adversity can happen at any time before the completion of the well to its last functional detail, safety measures to weather off such events at any step of the construction have to be in place, before beginning to undertake such operation. This CIP application enumerates a model of a ‘Detachable Island Rig’ (DIR). This is one among the diverse measures described in the parent application by the Inventor Applicant, said measures however working in synchrony, to weather off any unforeseen event throughout the well construction and well operation. For the information of the said devices otherwise operative, the original application (titled as ‘Emergency Salvage of a Crumbled Oceanic Oil Well’) may be consulted. The original application is also a parent application for yet another CIP application enumerating a prototype model of a ‘Subsea Level Gas Separator of Crude Petroleum Oil’ (SLGCP) that includes means and methods to be incorporated, beneficially as the most proximate outlet of the well head feasible, and at the earliest occasion, for preventing a giant gas bubble formation so as to keep the rig from being a venue of danger, difficult to contain. The subject matter is contextually relevant (to any oil company), being also preventive in scope, of otherwise catastrophic and totally devastating consequences of a rig-fire.

Many inadvertent and unforeseen consequences were/are inherent to such ventures as the deep sea explorations and the like, shrouded in dangers and never ceasing mystery, and counting always on the tides of nature yet to be conquered by technological sophistication. Accordingly, the Author Inventor is neither legally liable nor personally responsible for any inadvertent errors or for any ‘adverse events’ difficult to differentiate either as a mere association or as a consequence of the application of the structural and procedural information herein enumerated. Application of this disclosure in different situations, innumerable and unique, is a personal choice. Furthermore, understanding, analyzing, and adapting swiftly as needed, to diverse situations, still remain as the professional discretion, expertise, and the deemed responsibility of the involved company and its associates participating in the day to day practice in the implementation of this invention, in part or as a whole.

A drilling rig in its simplest form can be defined as an unit of equipment built to penetrate the superficial and/or deeper aspects of the earth's crust. The rigs can be built as small and portable to be moved by single person. However, they can be of enormous size and also suitably equipped for complexity of functioning, so as to house equipment used to: drill oil wells; sample mineral deposits that can impede functional units; identify geographical reservoirs; install underground utilities. Large units of drilling rigs, generally configured as more permanent land or marine based structures in remote locations are also facilitated with living quarters for laboring crews involved in well construction, at times hundreds in number. The rig as described can be permanently based in the sea, or floating with partial submersion.

Based on the cost of the multiple equipment of the rig and the life of personnel involved, even a major part of a permanently based rig may be constructed as a detachable island from the base structure and the area of conductor platform, the possible site of the initial fire or explosion. The detachable island is devised to be separated from the said site by a stretch of fire-proof corridor of sufficient length. Ground stability can be a considerable factor for the oil companies in opting for a permanent base. In the model herein described, the Detachable Island Rig is devised as an immovable structure with desired ground stability, yet with schema of provisions to quickly steer away from the permanent base structure and the adjacent conduction platform, if the ‘fire/dangerous gas alarm’ goes off, as a warning to the crew.

### BRIEF DESCRIPTION OF THE INVENTION

The embodiment of inventions herein disclosed is directed towards emergency devices that envision an emergency ‘Detachable Island Rig’ (DIR), to keep an off-shore oil well rig from being a venue of danger (and to possibly effectuate an emergency rig-salvage), resulting from a catastrophic ignition fire, proved difficult to contain.

The disclosure enumerates a ‘Detachable Island Rig’ (DIR) stationing on a stable concrete base and having a car door like locking device to be disengaging from or engaging with the base of a solid immovable structure. The DIR contains additional conduction platform, costly equipment, reserves, living and working quarters, and at the farthest end a steering station having powerful engine to speed steer in an automated straight course following a remote signal by the crew. For stationing back onto the permanent base structure that is built to stay submerged even by changing tides, the DIR is pulled down by a system of double pulleys situated in strategic positions on the sides of the base structure. The said pulleys have pull-over metal ropes hooked at their upper terminals to series of rings located at strategic places on the sides of the DIR when also the DIR is positioned to be locked to the permanent base structure. The metal ropes ultimately are pulled by yet another system of double pulleys located in the underwater basement or outside, the said basement also housing electrical generators, the ‘power source’ throughout the rig operation. The detachable rig has specially devised life boats and lift boats (the latter to rescue seriously injured or unconscious fire victims from ocean waters) with wheels, the said boats stationed around the deck to be lowered into the sea by projectile ramps in the event the DIR also catching fire that cannot be contained.

### DRAWINGS

FIG. 1: ‘Plan of an Emergency Detachable Island Rig’—a schematic diagram of the workable outlines.

FIG. 2: ‘Anchoring Model of a Detachable Island Rig onto a permanent base structure’—a schematic diagram.

FIG. 3: ‘See-saw Hammock Design of a Lift-boat in a Detachable Island Rig’—a schematic cut-section in part diagram depicting the interior of a ‘lift-boat’.

### DETAILED DESCRIPTION OF THE INVENTION

The embodiments of inventions herein disclosed are directed to devices effectuating an emergency salvage of an off-shore oceanic oil well rig that envisions an emergency ‘Detachable Island Rig’ (DIR), its devised scheme deemed to keep the rig from being a venue of danger following an ignition fire, otherwise proved difficult to contain, in view of past experiences of record worldwide. The disclosure further enumerates numerous accessories for the most effective design of a DIR that also incorporates ‘life-boats’ and ‘lift-boats’ uniquely structured to be operative in any catastrophic events, settings, and their consequences.

The rig as described in the fore going sections, can be either permanently based in the sea, or floating with partial submersion. Based on the cost of the multiple equipment, and the life of personnel involved, even a major part of a permanently based rig may be constructed as a detachable island from the base structure and the area of conductor platform, the possible site of the initial fire or explosion.

Ground stability can be a factor in opting for a permanent base by the oil companies. In the model herein described, the Detachable Island Rig is an immovable structure with desired ground stability, yet with provisions to quickly steer away from the base structure and the adjacent conduction platform, if the ‘fire/dangerous gas alarm’ goes off, as a warning to the crew. The detachable island of the rig is devised based on the fact that there is no need for the whole rig to be destroyed with the fire feeding on itself incessantly, as in the manner it happened in the Deep Water Horizon Oil Well explosion, in the Gulf Shores. Whatever can be salvaged should be always salvaged, including all the personnel in one pack, working together for steering away the DIR from the source of fire, soon to be turning into a raging inferno.

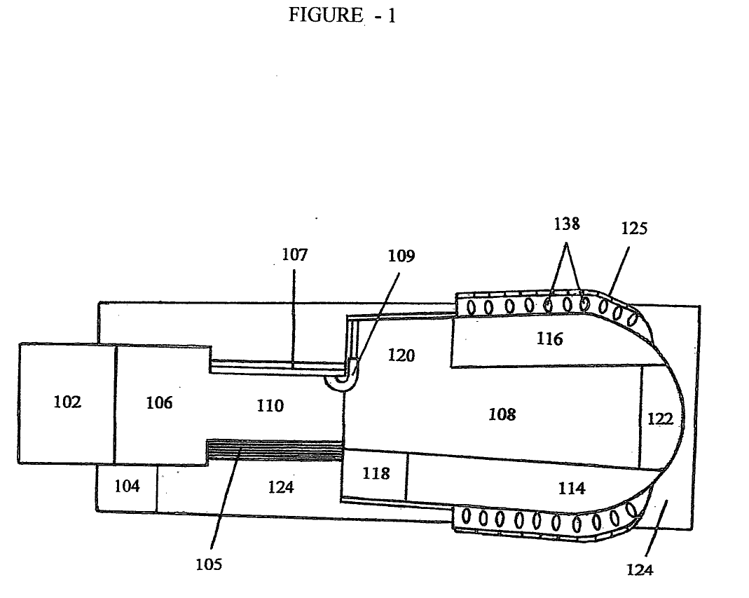

FIG. 1 shows the schematic diagram of a plan outline of a proposed typical oceanic rig that includes a ‘Detachable Island Rig’ (DIR) within its structuring. Consistent with FIG. 1, on one end of the rig is the conduction platform 102 that also includes an appendage of fire station 104 with the crew. The adjacent segment 106 stations structures needed for the immediate operations of the conduction platform 102. The structures 102 and 106 are connected to the Detachable Island Rig 108 by a stretch of fire-resistant corridor 110, sufficiently long. The tubing and wiring running to the DIR 108, traverse both sides of the corridor, its one side accommodating electrical wiring 105, and the other side accommodating metal tubing 107. The metal tubing 107 is preferably substituted by a short segment of suitable rubber tubing 109 at the junction of the corridor 110 and the DIR 108. Every metal tubing in the rig has threading inside or outside, for needed immediate repair and intervening articulation by ‘joint tubing’ devised in I, L, C, J or T shapes having a complimentary threading with a straight or nested configuration.

The DIR 108 is detachable from the fire-resistant corridor and houses the costly and heavy equipment, supplies, needed reserves, working area 114 (having remote controls to the conduction platform, well head, and all functional and security devices), and living quarters 116 for the crew. Such separation of the DIR through the fire-resistant corridor 110 gives few minutes time for the DIR to escape from the fire, and to be steered away from the permanent base structure of the rig. The DIR 108 also accommodates a fire station 118 with its own crew, additional conduction platform 120 with a basic structure to be fully equipped as needed, and a steering equipment with a powerful engine positioned in the farthest end 122, similar to that of a small ship in its scope of operations. The DIR as a whole is stationed on a concrete platform 124, erected from the sea floor that behaves like a permanent base. It is most suitable if any structure like a room or a wall, either in the fixed base 102, 104, 106, or in the DIR 108 are designed to be easily dismantled, to be arranged into a different configuration as needed, during the time of restructuring. It needs to be understood that the central portion of the DIR numbered as 108 is also an area for important heavy and immovable structural devices to be situated, in turn connected to the areas 114, 106, 107, and 105. It has to be also noted that the schematic FIG. 1 only shows the possible plan of the rig, but may not precisely represent the true shapes, exact dimensions, or operative configuration of a workable model of an off-shore rig, as it is only intended to show a workable plan by which the detachment of the DIR 108 can be easily accomplished, and how the structural arrangement should be geared towards that goal.

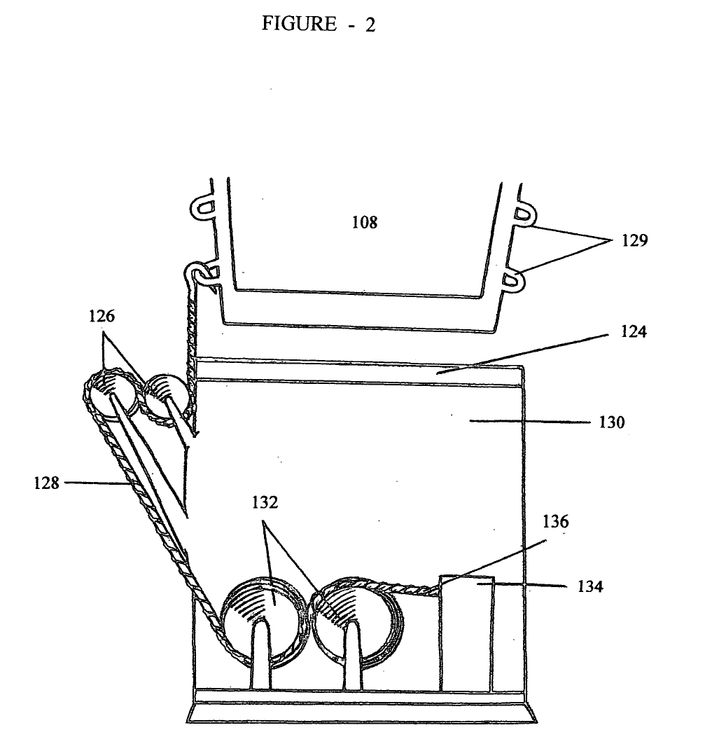

The concrete platform base 124 of the DIR 108 is so structured that it is at a sufficiently low level from the water surface, so that the island rig 108 can be steered down onto it, to be immovably locked in a desired position. To that effect, suitable mechanical forces have to be in place to overcome the built-in buoyant forces of the DIR, and bring it down by few inches, to be rested on the solid base 124. A device of double pulleys 126 as shown in FIG. 2, strategically positioned at multiple sites on the side walls of the concrete base 124 are devised to maneuver a set of sliding metal/steel ropes 128, their upper ends hooked to the ringed structures 129, positioned on the sides of the DIR 108, so as to correspond to the positions and intervals of the pulleys 126. Additional rings 129 can be positioned at higher levels also, as such positioning at times may be better operable for the steel ropes 128, to be exerting downward traction on the DIR 108. Traction of the steel ropes 128 on all pulleys 126 simultaneously will bring down the DIR 108 by few inches on to the concrete/steel base 124, to be stationed on it in desired position.

The underwater basement 130 of the concrete permanent rig base 124 also houses devices of double pulleys 132 (in the corresponding positions of the pulleys 126 located on the walls of the concrete base), also working on the sets of steel ropes 128, exerting traction in a complimentary direction, the movement of the terminal part 136 of the metal ropes 128 being aided by the electrical forces of the motor equipment 134. In the maneuvered position of approximation of the pulleys 126 and the rings 129, the DIR 108 is also in a position for locking with the permanent base structure 124, effectuated by remote controls. After a secure locking, the steel ropes are detached from the rings 129 of the DIR. The set of double pulleys 132 and the electrical motor equipment 134 can be located outside the basement also, that is, the pulleys can be located in a manner similar to the pulleys 126, which can make the structuring easier.

It can be a matter of concern of how to access the underwater basement 130 on a regular basis from the DIR, without an unwanted compromise. The area 120, the additional conduction platform for future use (if needed, as per the plan of FIG. 1), can be tailored for this purpose. On the permanent base 124, a rectangular roof window of the basement is constructed in a position corresponding to the area 120 of the DIR. The basement roof window (BRW) has a water-tight door similar to that of a car trunk that can be unlocked by remote control, and the BRW door (BRWD) lifted up. Few inches outside the BRW borders there is a provision on the basement roof structure 124 to articulate with a rectangular erectable staircase room (SCR), preferably in sturdy steel, made of four walls, the said walls to be articulated in situ with each other while also articulating with the basement roof structure 124, to create the said SCR around and above the BRW. The footage dimensions of the SCR around the BRW on one side is greater than the rest, so that it can accommodate a spacious ladder (or a steep stair-case) and also two or three men to stand next to the BRW. The articulations of the SCR with the basement roof structure 124 is also similar to a car trunk that can be unlocked with remote control. The SCR indeed is erected into, and is communicating with the DIR through an open area created in the area 120, and the SCR has a watertight DIR access window door (DAWD) at the top. The height of the erected SCR structure with tailored dimensions is deemed to surpass the level of the ocean waters, with provision to append when the ocean tide rises. The open DIR floor itself in the area of 120 has another similar DIR enclosure (DE) that surrounds the SCR, and in turn covers the SCR with its own watertight DIR floor door (FD). The roomy underwater basement 130 has a sturdy and wide staircase with a terminal ‘standing-structure’ (SS), said SS situated just below the BRWD. That is, when BRWD is lifted up, and secured to the side of the SCR, the SS that can accommodate many people or large mechanical structures is immediately accessible from the ladder area and the other three sides of the SCR. The FD and DAWD can be usually kept open without the danger of water getting in. However, BRWD is always locked (to be safe-guarded from unforeseen circumstances), except during the time the basement 130 is entered. The two sides of the SCR adjacent to the DRAW are connected to lift-prongs that work to lift up the structure from the base structure 124 after the SCR is unlocked from the base by remote control. This provision is essential in the event of a rig fire, for the DIR's disengagement, to be steered away from the permanent base 124. It is feasible, as the structure is in close proximity to the crash cart, and the needed steps may not be over looked, the crash cart also having remote controls for the unlocking operation. However, the DIR enclosure (DE) structured around the SCR will not prohibit such disengagement of the DIR. The BRW being always below surface water level, the basement will be never involved in fire even when it is too late for the DIR to be disengaged and steered away. When DIR returns to the base structure after a fire and is stationed, when the area 120 is destined to function as a conduction platform, the BRW may be positioned outside the confines of the DIR. However, similar structures (with similar principles, but some needed modifications) as described earlier can be constructed, with the SCR connecting to the DIR through side walls of either, by an intervening small bridging structure far above the water level (or else through an access ladder or a staircase on the base structure 124), to reach the area about the top of the SCR ladder. The DIR should have provisions for small constructions like this, to weather through any circumstances. The oil company can opt to construct the basement entry solely in the latter described manner, however with provisions to disengage the bridging structure on the DIR side, when needed. In summary, the principle is, the basement is accessed in any manner, through its roof structure erected to be far above the water level, however with needed security measures. In right positioning the DIR 108 can be locked (or unlocked) by mechanical equipment similar to the locking of a car door (in magnified size with an allowance for some imprecision) by a remote control. These locks are multiple and are located all around the floor of the DIR, except in the area of 122, where the engine motor for the DIR steering is located. Control buttons for locking and unlocking can be pressed one after the other, all being also controlled by a single universal button for each side, such universal buttons amounting to a total of three. With a press of the fourth button following the upward rise of the DIR to the water surface, the engine of the steering station 122 is activated to take an automatic straight course until the control is taken over by the crew. The DIR is structured to have retractable wheels, omni-directional like those of a shopping cart, for finer adjustment (all four wheels controlled to work in synchrony) of the DIR's positioning on its base platform, said wheels structured to be projected down during the time of repositioning on the permanent base structure. Other mechanical anchoring devices available in the market can also be used additionally, for the immovable stationing of the DIR.

It can be noted that when the detachable rig 108 returns to be stationed on the permanent base 124 after a rig fire destruction followed by needed demolition, all the locking devices may not be properly approximated to be operative, but even few in strategic positions, especially in opposite corners are effective and functional for a stable DIR stationing, also aided by other suitable mechanical devices, if necessary. The underground basement also houses electrical generators needed for the whole operation of the rig. Being housed in such under-water basement, the chances of the generators being destroyed by fire are minimized, this equipment being the ultimate ‘power-house’ for survival off-shore.

At the junction of the fire resistant corridor 110 and the DIR 108, a crash cart is equipped to disconnect the metal tubing 107, and the wiring 105 that connect the two areas 110 and 108. Each tubing and wiring is differently color coded, and every member of the crew including the fire fighters should know how to instantly disconnect or severe, and clamp or seal each tubing and the wiring. At the junction of the corridor 110 and the DIR 108, the metal tubes 107 are made of short connecting segments of rubber tubing. If they are coursing on the wall, this part of the connecting rubber tubing should have a U or C configuration 109 for easy clamping and cutting. The ends of each metal tubing 107 adjacent to the C or U junction can be clamped by any conventionally structured mechanism, before cutting the intervening rubber tubing. The wiring 105 is carefully cut and sealed/insulated on either side. Working with remote devices as much as possible should be the priority to minimize the wiring within the DIR.

The signal to unlock the locking devices of the DIR from its permanent base structure 124 should be set by the key personnel carrying the remote control, as soon as the connecting tubes and wires are severed. Similar signal also activates the engine to speed steer the DIR 108, in an automated straight course away from the venue of danger. Multiple sheets of wet jute burlap stored in reserve at strategic places in a roof structure of the rig, and above heavy equipment, and thrown on burning objects/equipment, or affected crew members, is the most effective way of putting off the fire, even from inflammable gases, in conjunction with instantly closing the tubular systems (with the devised threaded configuration of all the tubular systems, through their entire lengths, and also the devised ‘closing caps’ with complimentary threading, as envisioned in the instant invention, to be detailed subsequently) to shut off the unceasing inflammable gas emissions at any level, from the broken and otherwise irreparable tubular system. The stored burlap sheets/rolls should be instantly made wet by out-poring jets of sea water. Additionally, the costly equipment can be wholly jacketed/sheathed with layers of fire-proof structure during manufacturing, their tubing connections threaded throughout to establish a subsequent connection in case their connecting tubing or appended structures are destroyed.

If the DIR 108 had caught fire before or after its detachment, powerful sprinklers spread all around, jetting water from the sea, should be activated, and control of fire should be easier as the DIR 108 is moving away from the source of danger. Rescue attempts from outside should be immediately activated also. Life boats 138 with wheels are also kept in reserve on board. They are positioned all around the periphery of the DIR 108 in guarded enclosure cubicles (with thick plastic curtains covering them on the ocean side), to be mobilized into the water by sloping projectile ramps 125, operative by remote control. The boats will not be weather-beaten, if positioned at a safe distance from the edge.

The crew can move away only as far as it is deemed safe, but continuously working on the security and functional devices through remote controls, keeping vigilance on the expert professional fire crew left on the deck, working on preventing the well explosion. The DIR with crew can return to the original rig area as soon as the fire is put off, and station the DIR 108 to start the reparative process, using the additional conduction deck 120, if the damage to the immobile structures inclusive of the original conduction deck 102 is substantial, and cannot be immediately repaired. But a restoration should be possible. Quick surface demolition can be done, as in this situation, clearing of the wreckage into the ocean is easier and less time consuming than a ground demolition. The DIR 108 can be moved farther on to the concrete base so that the area 120 can over-lie the area 102. In this instance, the locks in this area of the base 124 may not be all around, as was already mentioned, but even few strategically placed locks are sufficient for structural stability. The basement housing the generators should be diligently constructed, to withstand any calamity so that immediate electrical circuiting is restored. Once the emergency reparative processes to restore the temporary well integrity followed by reparative processes to restore the permanent well integrity are accomplished by plurality of measures as was described in the original application (titled ‘Emergency Salvage of a Crumbled Oceanic Oil Well), any further new and planned structuring of the rig can be done, for needed ongoing maintenance. Work and the amenities needed in the rig at the time of well maintenance probably are not as demanding as those needed at the time of well-digging.

When it is clear by all means that the fire can not be contained by any available techniques, and staying back can only endanger the lives of the fire-fighter crew, every crew member should steer away, and nobody left behind. It is in the best interest of the crew that everybody gets training in basic fire-fighting, though few are experienced and highly skilled. Those skilled, and stayed back, should plan to jump into the ocean in life threatening situations, or when they catch fire that could not be contained. They must dive-in as long as they can, in case they had caught fire (to avoid surface oil or crude that may not be visible in darkness) and must swim to clearer waters, that is, towards the darkest direction, and away from the rig/fire. The DIR crew should have powerful binoculars to keep vigilance, and as they steer away, they should let out some lift-boats stationed on the base structure, into the ocean, that are anchored to the stable rig platform by lengthy ropes, so that the fire fighters who jumped into the water can reach them.

The life boats should have water-proof light source to be located if the calamity happens after darkness. The life boats-also should have provisions for the ‘rescued’ to get in swiftly, as the fire can be spreading on the water surface also. They should have two hanging ladders on one side. On the other side, the hemi-section of the boat is built much heavier to stabilize the weight of the person and prevent the boat from toppling, as the person tries to climb up. Alternatively, the boat can have helium-filled sacs secured (by Velcro i.e. the generic ‘loops and hooks’) to the inside of the boat on the side of the ladder so that the boat will not topple while the person tries to climb up. In this situation, the occupants should prefer to sit on the side of the ladder to offset the tilt of the boat on the water, or else disengage some helium-sacs to be fixed to the opposite side also. Being secured to the interior of the boat, the chance of the helium sacs getting punctured during the mobilization of the boat is minimal. The boats should have wheels in the bottom to mobilize them from the rig into the water over the sloping projectile ramps. The boat on the side of the ladder should be painted with alternate black and white stripes (to aid approaching from the right side, that is, the ladder side of the boat), whereas the rest of the boat is painted white that helps enhanced visibility in darkness. The boats should have solar-powered batteries for the light source that can be activated by remote control (simultaneously when projectile ramps are activated) in the event of a catastrophic consequence in the nightfall. All the boats should also have fire resistant surface, secured oars inside, and snaps for instant disengaging of the metal ropes, to steer away from the rig. The first-aid materials for fire victims, including analgesics (pain killers, like Tylenol) should be stored in a water-proof compartment in each boat.

In addition to the life boats there can be ‘Lift-boats’ in the rig, solely meant for rescuing severely injured crew members to be lifted up from the ocean waters into the boat, if they are extremely weak, or losing/lost consciousness. The lift boats are specially designed for such purpose incorporating most of the features of the life boats. It needs to be noted that though a victim can be pulled easier under-water, lifting them up is harder, as once the victim is above the surface of water, the weight in air comes into force, and additionally, the rescuing person has no solid-footage to bear and lift even a moderate weight. A very strong person may tilt boat totally down with one hand, to roll the rescued into the boat with the other hand, and then straighten it for himself to be getting in from the opposite direction.

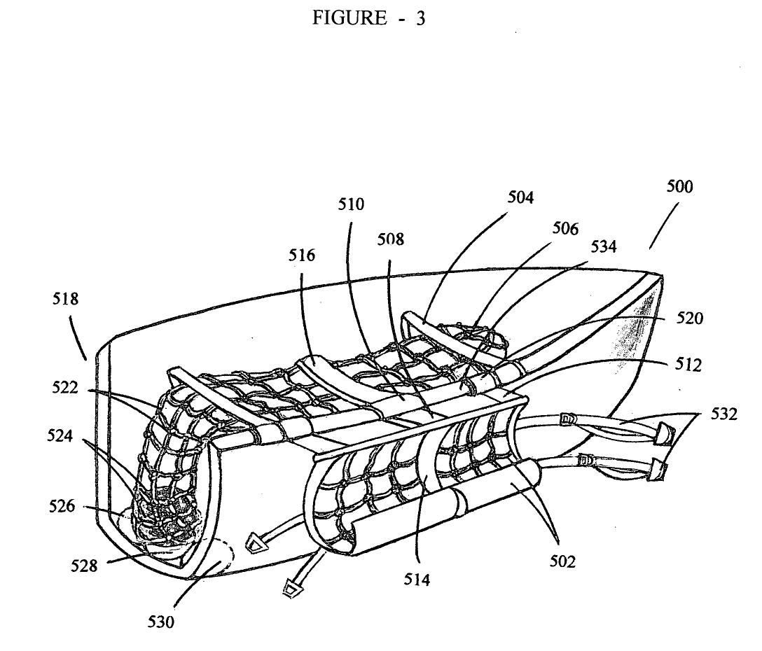

The FIG. 3 illustrates the schematic model of a lift-boat 500, better devised to be larger than life boats so that more people can be accommodated. To provide room and stability, its bottom is best made as flat base rather than a sloping base. It has a lift-hammock (LH) 502 on one side of its exterior. The said LH 502 is made of a strong nylon net that also has a weather resistant canvas as a lining, and is covered by soft padded sheet, tied to the hammock on four corners by Velcro bindings. The soft padded sheet of the LH 502 also has pillow like thickened cushions on either side, to prevent head injury to the victim by any sudden tilting of the boat. The LH is supported by metal flanks 512 on either side that are fixed to the boat by movable hinges 520, axially rotating on a metal or wooden rod 534. On the other side of the boat, there is a ladder, not shown in the figure. For descriptive purpose, the LH side of the boat is referred as hammock side (HS), and the ladder side referred as ladder side (LS). The boat has four wheels similar to life boats, however not shown in the FIG. 3.

On the hammock side of the boat interior there is also a receiving hammock (RH) 506, made of metal reinforced nylon net lined by a canvas, and supported by fixed supports 504, that also can be slid down by mechanical aids, when it is so desired. The center of the RH 506 is configured to have a long plank 516 of a see-saw like device, connected to a short plank 508 of the see-saw by a movable rotating hinge 510 that axially moves about the boat rod 534. The short plank 508 is also perpendicularly connected to the central support 514 of the LH 502, said support devised as a strong structure. The LH 502 is also reinforced by additional supports on either side. The RH 506 on both sides incorporates bag like extension net-work 522, that hang down to the bottom of the boat, and each bag 522 contains a heavy-weight metal sphere 524 that stations in one of the three sockets 526, 528 and 530 in the flat bottom of the boat, the socket 528 being centrally located, whereas the socket 530 is located on the HS, and the socket 526 on the LS of the boat. The cut-section in part 518 of one side of the boat interior depicts such structural arrangement.

During rescuing of a burnt victim, the rescuer after swimming to the HS of the boat along with the victim, positions the victim in the LH 502. Objects being lighter in water, it is easily done, and the rescued is secured by restraint belts 532 that have larger than usual size adjustable buckles for easy identification and handling. The Velcro bindings of the hammock cushion in the lower corners are untied at this point. The LH 502 being of moderate size, even two people can be belted at one time. Cross belting is more secure. When the boat is unoccupied, the metal sphere 524 on either side is routinely positioned in the socket 526 on the LS of the boat, being secured in that position by the loops of the bag-net anchored to a hook on the LS of the boat interior. Similarly, there are hooks on the HS, and also on the corners of the boat to station the weight 524 in the desired socket.

With the weight of the rescued on HS of the boat, the weights 524 positioned in the sockets 526 on the LS, will stabilize the boat in upright position so that the unconscious victim will not be submerged in water. The rescuer will quickly swim to the LS of the boat to reach the ladder. From the top of the ladder the rescuer will move one of the spheres to the socket 530 on the HS after unhooking the net from the LS of the boat. To enable it, the oars are secured to the LS of the boat, each oar having a spoon shaped end to sway the sphere 524 to the socket 530 by sliding over the central socket which can be easily done on the right side by a right-handed person. The boat also has a thin rod with a metal hook at the terminal to unhook the net to start with, and then to hook the net to the HS of the boat to station the sphere 524 in socket 530. Positioning of the spheres on both HS and LS will balance the weights evenly while the rescuer(s) climb up the ladder to board into the boat. Avoiding undue or sudden movement of the boat will prevent the victim hitting himself against any hard part of the LH 502 (the burnt body surface being highly sensitive even to mild touch, unless the nerve endings are destroyed). This maneuver of moving the sphere may be omitted in the night or during low visibility when it may cause undue delay.

After getting into the boat, the rescuer will unhook the bag nets from both the hooks, disengage the spheres from the net bags, to position both the spheres in the central sockets 528 (the largest diameter of the sockets 526, 528, and 530 are larger than the largest diameter of the sphere 524, and the length of the bags are just sufficient to be moved to either side of the center) and hangs the sides of RH net in a lax manner to the hooks of the fixed supports at strategic places so as to allow the free downward movement of the central plank. The rescuer will immediately position himself on the RH 506 to lower the long plank 516 so that the short plank 508 and also the LH 502 will be lifted up as a result. The rescuer should stay in a best position to be able to pull and receive the victim into the RH 506, by holding all the corners of the LH cushion, after disengaging the upper Velcro bindings also at this time. The spaces between the network of the RH 506 are big enough and without canvas to accommodate the legs of the rescuer on either side of the plank, to sit or stand if either position is more convenient.

The fixed hammock-supports can be unscrewed to be slid down to rest against the side of the boat so that there is sufficient room in the boat. The spheres 524 are stabilized in the central socket 528 by placing within and hooking the bags to the corner hooks of the boat, to prevent their unwanted movement in the interior of the boat.

In a different embodiment, the lift boat can have helium filled sacs secured by Velcro to the inside of the boat on the LS so that they will offset the weight of the LH with the ‘rescued’ so that he will not be submerged in water. In this situation, there is no need for the metal spheres, the sockets, the net bags, and the fixed supports. The receiving hammock net is fixed to movable long planks on either side (substituting and occupying the position of fixed supports 504), the planks being connected to the hinges 520 to be maneuvered as a see-saw also, while all the planks are also connected by a cross bar adjoining the edge of the boat.

The lift boat interior can be lined by bubbled air mattress on the bottom protected by weather resistant canvas to be able to nurse the victim resting on such shock absorber. A bubbled mattress is better protected following an isolated puncture than a single-compartment air mattress. A sponge mattress is also an alternative. The surface canvas can have restraining belts in strategic positions so that the victim's body will not be unduly jolted by the rough tides of the ocean.

Lift boat with inflatable lift mattress—in yet another embodiment the LH is provided with an inflatable mattress (securely protected by properly sized and expandable knotted mesh on the top, and further covered by properly sized padding, both allowing needed expansion) that can be air inflated by a pump securely protected inside a boat compartment. After a victim is restrain-belted (said belting will not hinder an upward expansion of the air mattress), the mattress is air inflated to rise to the level of the edge of the boat. The air mattress is configured narrow in its width to be sufficient to accommodate the body of a victim, but suboptimal in its length—such provision minimizing the time of air inflation, for the mattress to rise to the edge of the boat. That is, it is structured and positioned like an air-bench (that is lifted up in vertical height) rather than a standard ‘air-mattress’ that it is named as. It is also tied in strategic places to keep such positioning even before it is occupied. The mattress can also have an incline towards the boat interior so that the victim can be slid inside easily. Additionally, it can have wide-cavity egg-crater like configuration throughout, with widest cavities in the centers of the side walls and the bottom, to minimize the air needed, yet serving the purpose of air-lift without compromising comfort. Air pumps and other devices made of metal are preferred, or else they are made to be in-built in the boat, to minimize any shocks and breaks. Solar-powered batteries are best suited for use. In the setting of the air mattress, if see-saw device is not chosen, a receiving hammock inside the boat is still desirable to safe-handle an injured victim, and not to aggravate pain. Soft padding with Velcro bindings is an optional in this setting, for sliding the victim's body as a whole. However, it is better to have the see-saw device also, as it is a sure (and swift) modality in case the air mattress had been accidentally punctured in the transit.

Multiple air pillows are also stored in the boat compartment of any boat along with IV (intravenous) transfusion fluids, few hospital gowns, and dressing supplies. The boat also has hooked rings on the walls to hang the infusion. All the wall-hooks in the boat interior are structured as ‘near circles’ so that whatever is hung (including the net bags) may not be accidentally disengaged. All the crew members usually know how to start an IV as they are also trained in basic life support (BLS) while they are trained in basic fire-fighting.

Which Device to Choose is Solely Based on the Seriousness of the Situation

If basic life support (BLS) like mouth-breathing and chest compressions are immediately needed, and even few minutes can not be expended to look for the needed inflating devices stored in the boat and then air inflate the air mattress, the see-saw is an instantaneous rescue. The lift-hammock is covered with soft padded sheet tied by Velcro bindings so that they can be immediately untied and the victim pulled along with the sheet to the rescue hammock inside, which is a swift and comfortable maneuver possibly done in this setting. It follows, what to use when depends on the seriousness of the situation. Air mattress outside on the hammock is a preferred device though finding the required air inflator in the boat followed by air inflating need few minutes to expend, yet with an uncertainty that the in-situ mattress is not punctured, as the knotted mesh is deemed to be protective only from abrasive punctures. Hence, it is wise to equip the boat with multiple devices that are called for in different situations, for a sure rescue. In the situation where the victim is unconscious, indeed it calls for immediate rescue, as it is a mixed case of burns, smoke-inhalation, shock, and additionally drowning.

A bigger rescue boat with sophisticated technology to lift the disabled victims is ideal, but in this situation the size of the boat should be far bigger to accommodate such technology. Additionally, as the oil/crude can be spreading on the water surface in the immediate vicinity of the rig, such rescue boat may not stay near by the rig to board more than one or two burnt victims, and the situation being chaotic, a burnt victim may tend to jump into water from any area of the rig, rather than trying to find the lift boat at a particular place. In such situation, it is better to operate all projectile ramps at once by universal remote control for the boats to slide down into water aided by wheels, so that a person can reach any one nearby. In a place heavily covered by smoke, and also when one's sensorium is deteriorating, rationally expected course is hardly accomplished. However, once out of the rig, and is in ocean waters, a person can rescue others who had jumped along with into the ocean, and are in a far worse condition, when also there are few lilt-boats floating around nearby. It can be a situation, when fire had spread suddenly, and there was no time to disengage the DIR, and the only measure possible is to operate the projectile ramps by remote control which every crew member should be always carrying.

Insurance coverage—the Insurance coverage of the damaged rig can be a factor in planning against a DIR. However, familiarity with the working devices of the old rig, remedial measures/damage control that can be immediately undertaken without losing precious time in a precarious situation when such measures are also easier than when they are under taken later, and most importantly, avoiding morbidity or mortality of the crew members, and many other aforementioned matters—are the factors in favor of constructing a detachable island rig. Finding a new rig that fits the company's immediate needs and options is enormously time consuming causing indirect waste of money in such time lost. The insurance premium can be lower, and an agreement may be planned for covering the needed construction, parts, and repair, to restore the fullest and the best functional state of the partly damaged rig, as such undertaking is very cost effective for the concerned insurance companies also.

### Threaded Instant Joint Configurations

The invention further envisions a model of tubing directed to all tubular systems, and their methods of instant system joining or closing, for all future oil exploration units, or as a replacement-tubing for existing units. The model of tubular systems are structured to be having a deep threaded configuration on the inside or the outside, traversing the whole length, facilitating instant joining or closing of a broken or intact system, aided by means of—1) ‘instant joint structures’ shaped as I, T, J, L, C, U, Y etc. with complimentary threading, and having a straight or nested configuration, or 2) closing caps—also with complimentary threading. The tubing involved can be production tubing, oil collection tubing, tubular system involving the rig and its machinery, and any tubing wherein said configuration is deemed effective. Such structural mandate is as important as all the incorporated safety devices in case ‘fire and well surface blow out’ happen, resulting in a ‘disconnect’ in the system—when instant joining anywhere necessary is accomplished, or else instant closing of the system with closing caps is similarly accomplished. The configured joint structures shaped as specified above, are used as one or multiple joints. I and/or T joints are usually needed to aid incorporate other joint structures, to restore a conduit line or complex interconnections. The closing caps have an articulating tube with complimentary threading, said tubing progressively enlarging towards the terminal to accommodate a massively sized cap that can resist any undue pressure built up in the oil conduit system, and also suitable for easy and swift handling.

1. An embodiment of invention, directed to exemplary models of emergency devices and their methods, directed to an off-shore petroleum oil well rig, designed to be working in synchrony, not only by salvaging, but also by reparative structuring, thereby restoring either one or both of the temporary and permanent functioning of the rig structure, incorporating a schematic model encompassing a ‘Detachable Island Rig’ (DIR) stationing on a stable concrete base, to be instantly detached/disengaged upon the initiation of a rig-fire, and having the below set forth means plus functions:
(a) means for the DIR to instantly unlock/lock by a car door like locking device to be disengaging from or engaging with a solid immovable base structure, thereby the DIR also separating from an immovable conduction platform and an adjacent intervening stretch of fire-proof corridor having metal tubes and electric wires traversing its either wall that are instantly severed to be disengaged from the DIR,
(b) means for the DIR to be having: additional conduction platform, costly equipment, reserves, living and working quarters, and at the farthest end a steering station having powerful engine to speed steer in an automated straight course following a remote signal by the crew,
(c) means for the stationary rig and the detachable rig to be having their own fire stations and crew of fire fighters,
(d) means for the DIR to be incorporating car door like locking/unlocking devices on all sides except the side of the steering engine, designed in magnified size allowing room for some imprecision, and are operated by a remote control having a common button to each of the three sides,
(e) means for the detachable rig to be having life boats and lift boats with wheels to be stationed around the deck for lowering into the sea by sloping projectile ramps in the event the DIR also catching fire that cannot be contained, the projectile ramps operated by remote controls carried by all crew members,
(f) means for all the metal tubing passing through the stretch of the fire proof corridor to be conforming to a short segment of rubber tubing having C or U configuration at the junction with the DIR, to be cut after clamping, facilitating instant DIR detachment,
(g) means for the DIR to be having projectile wheels like those of a shopping cart, for facilitating its precise positioning on its base platform,
(h) means for stationing back onto the base structure that is built to stay submerged even by changing tides, wherein the DIR is pulled down by a system of double pulleys situated in strategic positions on the sides of the base structure, said pulleys having pull-over metal ropes hooked at their upper terminals to series of rings, located at strategic places on the sides of the DIR, when also the DIR is in a position to be locked to the permanent base, the metal ropes ultimately pulled by yet another system of double pulleys located in the underwater basement or outside, the said basement also housing electrical generators, the ‘power source’ throughout the rig operation,
(i) means for the DIR to be having room to store large sheets/rolls of wet jute burlaps in its roof structure, to be thrown on the burning mechanical devices of any height (also designed to be also covered by fire-resistant sheaths/jackets during manufacturing), or on affected crew members, being effective even for flames emanating from inflammable gases, this working in conjunction with the means of instantly closing the tubular systems with the devised threaded configuration throughout, so as to be closed by ‘closing caps’ with complimentary threading, to shut off the otherwise unceasing inflammable gas emissions anywhere in the rig unit, or outside,
(j) the DIR having means to access the underwater basement through the top of a stair-case room erected from the basement roof, to rise far above the level of the ocean waters, with provisions for the DIR to be structurally disengaged when connected with close proximity.

2. The preferred schematic model encompassing the ‘Detachable Island Rig’ of claim 1, wherein the life-boats operative in the event of rig-fire have special features as set forth below:
(a) fire resistant surface, and two hanging ladders on one side,
(b) the whole boat painted white, and having intervening black stripes on the side of the ladders,
(c) the hemi-section of the boat on the opposite side of the ladders having thicker heavy weight wood, preventing toppling of the boat with the weight of ‘the rescued’ on the other side, climbing up the ladder, or alternatively having detachable helium filled sacs in the boat interior on the side of the ladders, to prevent the boat toppling with the weight of the rescued, few of the said sacs to be later positioned in the other side of the boat, to offset the tilt of the boat,
(d) having secured oars inside, and instant disengaging snapping joints with the anchoring metal chains,
(e) having solar-powered batteries for the charged lights to be put on by remote control, if the fire happens after a nightfall.

3. The preferred schematic model encompassing the ‘Detachable Island Rig’ of claim 1, wherein there are means for the ‘lift-boats’ to be operative following a rig-fire, for rescuing severely injured or unconscious victims from ocean waters, the model of a lift boat having special features as set forth below:
(a) a lift-boat devised to be larger than a life boat, while its bottom is best made as flat base rather than a sloping base,
(b) a lift-boat having a lift-hammock on one side of its exterior, said lift-hammock made of a strong nylon net, a weather resistant canvas, and a soft padded sheet tied to the hammock on four corners by Velcro, the lift-hammock supported by metal flanks on either side that are fixed to the boat edge by movable hinges, axially rotating on a rod,
(c) a lift-boat having a ladder on the other side of its exterior, this side of the boat referred as the ladder side, while the lift-hammock side is referred as hammock side,
(d) a lift-boat on the hammock side of the interior also having a receiving-hammock, made of metal reinforced nylon net lined by canvas, having fixed supports on either side, the center of the receiving hammock configured to have a long plank of a see-saw like device, connected to a short plank by a rotating hinge, said short plank further connected in perpendicular, to a strong central support of the lift-hammock,
(e) a lift boat incorporating bag like extension net-work that hang down to the bottom of the boat from both sides of the receiving hammock, each bag containing a heavy-weight metal sphere that stations in one of the three similarly configured sockets structured in the flat base of the boat, wherein one socket is located on the hammock side, and the other on the ladder side, both intervened by a central socket,
(f) the lift boat having means in the lift-hammock for securing a victim by restrain-belts, the metal spheres countering the added weight, being routinely positioned in the sockets on the ladder side of the boat while unoccupied, the metal spheres secured in any socket by the loops of the bag-net anchored to an adjacent rounded hook of the boat interior,
(g) the lift boat having means to equip the rescuer positioned on the ladder, to swaying one of the spheres to the socket on the hammock side, to stabilize the boat from undue tilting, such means facilitated by a hook rod, and a spoon-shaped oar blade,
(h) the lift boat having means to position both the spheres resting freely in the central sockets disengaged from the bag nets, soon after the rescuer is inside the boat, while the rescue hammock net is secured to the hooks of the fixed supports on either side at strategic places so as to allow needed downward movement of the long plank,
(i) the lift boat having means to lift the short plank and also the lift hammock, while the rescuer positions himself on the long plank and the receiving hammock,
(j) the lift boat further having means for optionally detachable helium sacs while the metal spheres, net bags, and the fixed supports are not devised in such structuring, and the receiving hammock is secured to a pair of long side planks movably connected to the side hinges of the lift hammock, said side planks also functioning as additional devices of see-saw,
(k) the lift boats having means for optionally detachable helium sacs (similarly functioning as those in the life boats) located inside on the lift hammock side, to prevent toppling of the boat with the weight of the rescued on this side,
(l) the lift boat having means to be lined by thin air mattress on the bottom to rest the rescued, the mattress covering canvas having restraining belts to prevent undue jolts of the resting victim.

4. The preferred schematic model encompassing the ‘Detachable Island Rig’ of claim 1, wherein the lift hammock of a lift boat is equipped with in-situ inflatable air mattress covered by a properly sized protective net, and by padded sheet, tied at all the corners by Velcro bindings, the air mattress having narrow width and vertical height, with deep cavity egg-crater configuration for minimal air inflation, to be best utilized for stable victims, with expendable time needed for air inflating the mattress to the edge of the boat.

5. The preferred schematic model encompassing the ‘Detachable Island Rig’ of claim 1, providing a model of tubing system and their methods of instant system joining or closing in all future oil exploration units, or as a replacement tubing for existing units, directed to all tubular systems about the oil well, the oil-collection system, and the rig, the said tubing structured to be having a threaded configuration on the inside or the outside, traversing the whole length of any suitable tubing, facilitating instant joining or closing of a broken or intact system, aided by means of (1) ‘instant joint structures’ shaped as I, T, J, L, C, U etc. having straight or nested configuration, said ‘instant joint structures’ incorporated as one or more, aided by at least one or two I joints, for assembling and restoring a straight or a complex interconnections, or (2) ‘closing caps’, to instantly close any tubular system, devised to have a stem of tubing with complimentary threading to connect, wherefrom it progressively enlarges to a sturdy and massive closing cap to resist enormous pressure possibly exerted within the tubular system at the terminal of a conduit line, or a complex interconnection.
